(19) United States
(12) Patent Application Publication
(10) Pub. No.: US 2012/0245762 A1
(43) Pub. Date: Sep. 27, 2012

(54) METHOD AND DEVICE FOR OPERATING A HYBRID DRIVE OF A VEHICLE

(76) Inventor: Jochen Fassnacht, Calw (DE)

(21) Appl. No.: 13/391,921

(22) PCT Filed: Jul. 16, 2010
(86) PCT No.: PCT/EP2010/060312

§ 371 Date: Jun. 7, 2012

(30) Foreign Application Priority Data
Aug. 25, 2009 (DE) 10 2009 028 867.8

(51) Int. Cl. B60W 20/00

(52) U.S. Cl. 701/2; 701/22; 180/65.28; 180/65.285; 903/903

(57) ABSTRACT

A method for operating a hybrid drive system of a vehicle in which an internal combustion engine and/or at least one electrical machine drive the vehicle, the electrical machine being supplied with energy from an energy reservoir or the electrical machine supplying the energy reservoir with electrical energy, and an operating point of the hybrid drive system being set in the context of a predefined operating strategy which depends on minimization variables that take into account the fuel consumption of the internal combustion engine and the energy made available by the energy reservoir. In order to configure the operating strategy of the hybrid drive system in as variable a manner as possible, energy from an external energy source is delivered to the energy reservoir, the minimization variables to be taken into account as a result of the delivery of energy from the external energy source into the energy reservoir being evaluated in the operating strategy.

### FIELD OF THE INVENTION

The present invention relates to a method for operating a hybrid drive system of a vehicle in which an internal combustion engine and/or at least one electrical machine drive the vehicle, the electrical machine being supplied with energy from an energy reservoir or the electrical machine supplying the energy reservoir with electrical energy, and an operating point of the hybrid drive system being set in the context of a predefined operating strategy which depends on optimization variables that take into account the fuel consumption of the internal combustion engine and the energy made available by the energy reservoir; and to an apparatus for carrying out the method.

### BACKGROUND INFORMATION

Vehicles having a hybrid drive structure have an internal combustion engine and, as a second drive unit, in most cases at least one electrical machine. Driving torque can thus be applied from both drive assemblies during driving operation of the hybrid vehicle. The electrical machine is acted upon, for example in a boost mode, with a high torque in order to enhance driving dynamics, whereas in normal driving the internal combustion engine is operated at favorable efficiency levels.

These operating strategies are implemented in a control unit of the hybrid drive system, so that control is applied to the electrical machine and/or to the internal combustion engine in a consumption-optimized, output-optimized, or pollutant-optimized manner depending on the requirement.

The electrical drive system is connected to an energy reservoir that supplies the electrical drive system with electrical energy. When the internal combustion engine is coasting, the electrical drive system works as a generator, with the result that energy is delivered to the energy reservoir by said drive system. As a result, the energy reservoir is recharged with energy. The energy delivered back to the energy reservoir is also referred to as “recovered energy.”

German Patent Application No. DE 10 2006 012 859 A1 describes a braking strategy for a hybrid drive system of a vehicle in which an energy-optimal operating point is determined when low braking torques are required, thus ensuring that the available recovery potential is optimally utilized. In order to establish the most energetically favorable variant of the internal combustion engine operating mode, a cost comparison for the extraction of energy for internal combustion engine coasting, and for the energy fed into the energy reservoir, is performed in the braking strategy.

### SUMMARY

A method according to an example embodiment of the present invention for operating a hybrid drive system of a vehicle may have the advantage that the energy extracted from a public electricity network is regarded as an additional type of energy and is also considered when setting the most favorable operating point of the hybrid drive system. Because energy from an external energy source is delivered to the energy reservoir, and the minimization variables to be taken into account as a result of the delivery of energy from the external energy source into the energy reservoir are evaluated in the operating strategy, a variety of cost function types or cost types, which are regarded as minimization variables, are taken into account individually or in combination when identifying the optimum operating point of the hybrid drive system in a given driving situation of the vehicle. The minimization variables can also be regarded as optimization variables.

Advantageously, the minimization variables take into account an energy equivalent and/or a CO₂ equivalent and/or a pollutant equivalent and/or a monetary unit. In the case of a CO₂ equivalent, the quantity of CO₂ per kilowatt-hour generated at an operating point is determined as a function of the quantity of energy loaded. Alternatively, the total quantity of energy extracted from the external electricity network is considered. The CO₂ emission generated by the vehicle is thus known in every operating situation of the hybrid drive system.

The same is true of the pollutant equivalent, which indicates the pollutants generated and emitted by the hybrid drive system, per kilowatt-hour and per quantity of energy loaded, at a specific operating point. It is also sufficient if the operating strategy is aware, in the context of identifying the most favorable operating point of the hybrid drive system, of an equivalent for a total energy quantity extracted from the electricity network, which can be, e.g., the charge at a known voltage. The operating strategy of the hybrid drive system also, however, takes into account monetary costs, such as money for a kilowatt-hour and quantity of energy loaded, or for the total energy quantity extracted from the electricity network.

In an embodiment, the operating point, set via the minimization variables, of the operating strategy of the hybrid drive system is implemented in a cost-function-optimized manner. The desires of the vehicle operator or vehicle manufacturer are taken into account in this context. Since, in addition to the minimization variables, the internal combustion engine power output, the electric drive system power output, and the power output that can be applied via the energy reservoir are known, the operating strategy sets the operating point of the hybrid drive system so that a minimum fuel consumption or electricity consumption occurs. A cost function optimization occurs whenever the operating point is set so that the lowest possible pollutant or CO₂ is produced and emitted by the vehicle. The minimization variables therefore allow the operating strategy the greatest possible variety of combination possibilities.

In a refinement, the minimization variables determined by the delivery of energy from the external energy source to the vehicle, and/or the quantity of energy loaded, are transmitted to the vehicle from the external energy source, so that the operating strategy can have the minimization variables available at any time in the context of determination of the operating point.

Advantageously, transmission from the external energy source to the vehicle of the minimization variables determined by the delivery of energy from the external energy source to the vehicle, and/or of the quantity of energy loaded, occurs wirelessly.

In another example embodiment of the present invention, transmission from the external energy source to the motor vehicle of the minimization variables determined by the delivery of energy from the external energy source to the vehicle, and/or of the quantity of energy loaded, occurs in contact-based fashion. Most simply, this occurs during the loading procedure. This ensures that this information necessary for the operating strategy is delivered in all instances to the vehicle, and is available for determination of the operating point.

In a refinement, the minimization variables are determined as a function of future values with regard to fuel delivery and energy delivery. “Future values” are understood in this connection as the costs that arise at various stations and are relevant to possible energy delivery. The operating strategy can decide, from the desired degree of optimization, what quantity of energy is to be delivered to the vehicle, at what moment, and at which energy supply station.

Advantageously, the minimization variables of fuel and energy are communicated to the vehicle during the loading of energy or of fuel. The minimization variables of the fuel or energy that has been delivered are thus immediately available to the hybrid drive system for processing in the operating strategy. The minimization variables can, however, also be saved and can enter into the consideration of the operating strategy later on.

Alternatively, the minimization variables of fuel or energy are transferred to the vehicle while the vehicle is being driven; this has the advantage that the driver not only can decide when he or she wishes to obtain information about the minimization variables, but also can decide which minimization variables are to be transferred.

A further refinement of the present invention includes an apparatus for operating a hybrid drive system of a vehicle in which an internal combustion engine and/or at least one electrical drive system drive the vehicle, the electrical drive system being supplied with energy from an energy reservoir or the electrical drive system supplying the energy reservoir with electrical energy, and an operating point of the hybrid drive system being set in the context of a predefined operating strategy which depends on optimization variables that take into account the fuel consumption of the internal combustion engine and the energy made available by the energy reservoir. In order to configure the operating strategy of the hybrid drive system in as variable a manner as possible, means are present for delivering energy from an external energy source to the energy reservoir, the minimization variables to be taken into account as a result of the delivery of energy from the external energy source into the energy reservoir being evaluated in the operating strategy. The energy costs of the energy reservoir are thus widened to include the costs of the energy loaded via a public network into the energy reservoir. The energy costs of the internal combustion engine and the energy costs of the electrical drive system can thus be taken into account individually or in combination when identifying the optimum operating point of the hybrid drive system in a given driving situation of the vehicle.

Advantageously, a hybrid drive system control unit determining the operating strategy of the vehicle is connected to the internal combustion engine and to the at least one electrical drive system in order to set the operating point, the hybrid drive system control unit leading to a first interface of the vehicle for receiving the minimization variables relevant to the energy that is transferred from the external energy source to the vehicle. This ensures that the hybrid drive system control unit on which the operating strategy is running, and which determines with the aid of the operating strategy the optimum operating point for the respective driving situation of the vehicle, is informed as to the minimization variables of the delivered energy, since these costs are known only to the operator of the electricity supply network.

In an example embodiment, the first interface is embodied as a human-machine interface. This has the advantage that the vehicle user inputs the requisite minimization variables into the vehicle, and additional technical means for transferring the information can be dispensed with; this presents itself as a particularly economical solution.

In a refinement, the first interface is embodied as a plug connector for an external communication system. An external communication system of this kind is disposed on or in the vicinity of the energy supply facility and furnishes to the vehicle, for further processing, the minimization variables associated with the transferred energy.

Advantageously, the first interface connects the external communication system wirelessly to the vehicle. Wireless interfaces already present in the vehicle can be used in this context for information transfer, resulting in a cost reduction upon introduction of the system.

In an example embodiment, the wireless connection between the external communication system and the vehicle occurs via a radio connection or an infrared connection or an inductive connection or an image recognition device.

In a refinement, the information regarding the minimization variables determined by the delivery of energy from the external energy source to the vehicle is modulated onto the charging current that flows from the external energy source to the vehicle in order to transfer energy. This action may ensure that the information is automatically transferred along with the procedure of delivering energy to the vehicle, with no need for additional manipulations by the driver.

In addition, a second interface transfers an information item about the minimization variables of the fuel to be exploited in the internal combustion engine of the vehicle. The information items about the minimization variables of the fuel being used not only increase the variety of values available, but also improve the accuracy of the calculations of the hybrid drive system control unit when determining the optimized operating point.

Advantageously, the second interface is a plug contact that is introduced into the fuel delivery device upon the reception of fuel, with the result that an electrical signal is conveyed from the fuel delivery device to the vehicle. Information transfer of the minimization variables of the fuel thus occurs automatically in the context of the filling procedure.

In a refinement, the second interface is a radio interface, an infrared interface, an inductive interface, or an image recognition interface. The use of interfaces that operate with wireless transfer methods increases the variety of usable capabilities.

In an example embodiment, the first and/or the second interface are connected to a vehicle control unit that communicates with the hybrid drive system control unit. Because the vehicle control unit is connected to a mobile telephone network or a navigation system that already possess wireless interfaces to the environment, additional interfaces can be omitted, since the one or more interfaces that are already present can be used for communication with the external communication system of the fuel suppliers or energy suppliers.

Advantageously, the external energy source is a public electricity network that is connected via an onboard charging unit to the high-voltage battery. The vehicle user can decide in this context as the external energy source from which he or she wishes to extract electricity for the high-voltage battery (from the public network or from a so-called energy filling station). Extracting energy from a public network, in particular, increases the possibilities for recharging energy.

The present invention includes numerous embodiments. One of them will be further explained with reference to the Figures.

### BRIEF DESCRIPTION OF THE DRAWINGS

FIG. 1 schematically depicts a example of a parallel plug-in hybrid drive system.

FIG. 2 schematically depicts information transfer of the minimization variables.

FIG. 3 is a schematic flow chart for execution of the method according to the present invention.

FIG. 4 schematically depicts the transfer of energy from the public network.

Identical features are labeled with identical reference characters.

### DETAILED DESCRIPTION OF EXAMPLE EMBODIMENTS

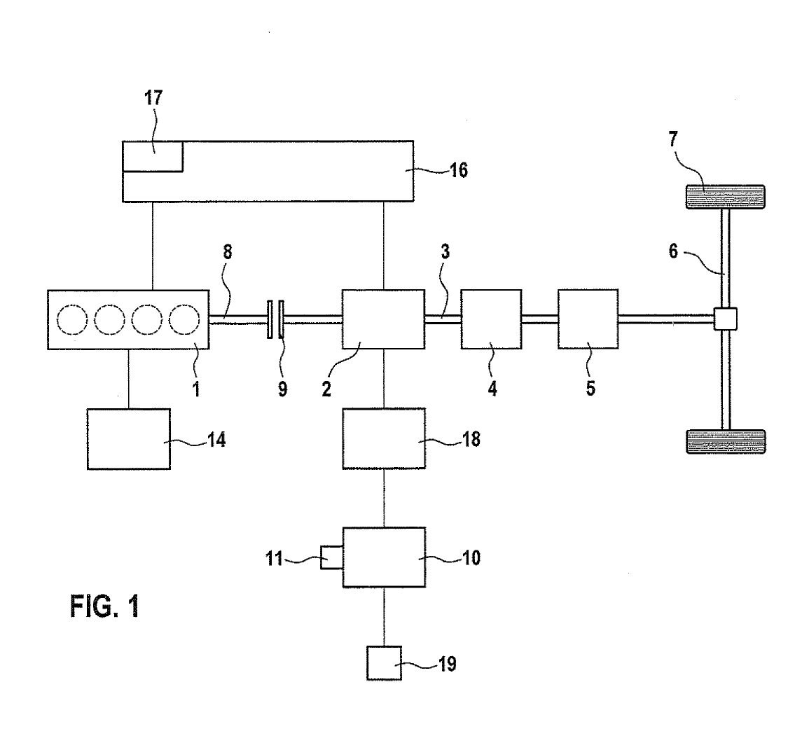

FIG. 1 is a schematic depiction of a vehicle having a plug-in hybrid drive system. The plug-in hybrid drive system is constituted by an internal combustion engine 1 as a first drive unit and an electric motor 2 as a second drive unit.

Internal combustion engine 1 is connected via drivetrain 3 to transmission 4, which in turn leads via differential 5 to wheel axle 6 in order to drive wheel 7.

Electric motor 2 is disposed on shaft 8 of internal combustion engine 1, and thus likewise leads to drivetrain 3 that is connected to transmission 4. Electric motor 2 thus contributes to the driving of wheels 7 and to the total torque of the vehicle. Electric motor 2 and internal combustion engine 1 are connected to one another via a separator clutch 9. When this separator clutch 9 is in the open state it allows the vehicle to be driven solely by electric motor 2, whereas with separator clutch 9 in the closed state, both internal combustion engine 1 and electric motor 2 contribute to driving the vehicle.

In addition, electric motor 2 is connected via a power electronics system 18 to a high-voltage battery 10 that supplies electric motor 2 with electrical energy when the latter is in its motor mode. Alternatively, when electric motor 2 is in the generator mode, the latter supplies energy to high-voltage battery 10; in other words, high-voltage battery 10 is recharged by electric motor 2.

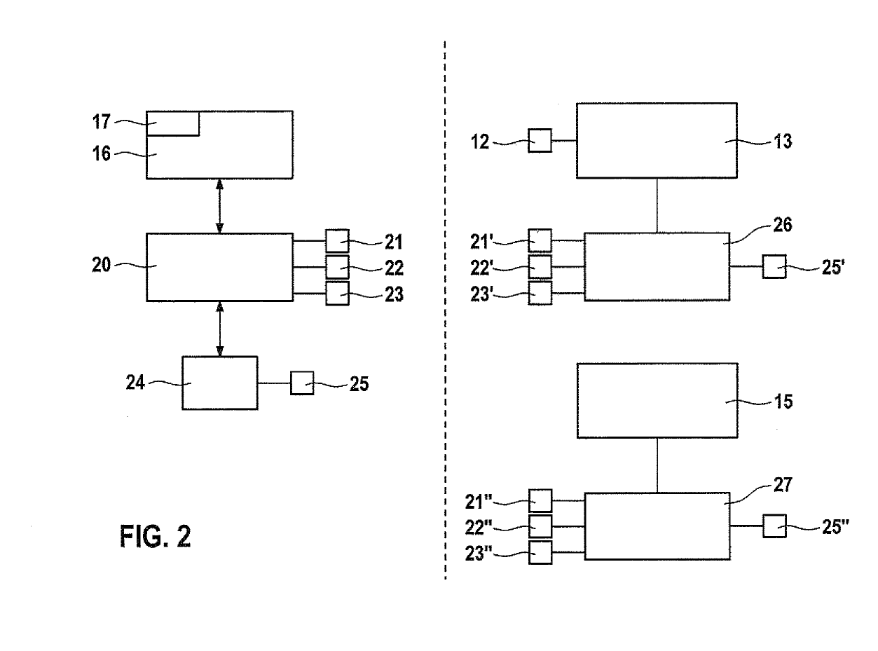

In the case of a plug-in hybrid drive system, high-voltage battery 10 has particularly large storage, capacities. In order to utilize these storage capacities, high-voltage reservoir 10 is supplied with external energy in addition to the generator mode of electric motor 2. High-voltage battery 10 possesses for this purpose a plug device 11 at which a plug apparatus 12 of an external energy supply facility 13 is connected (FIG. 2). Energy supply facilities 13 of this kind are installed, analogously to filling stations for fuel, in stationary fashion at predefined locations and must be traveled to by the vehicle for energy reception. Alternatively, charging can also occur from the public electricity network via an onboard charging unit. For energy reception, plug device 11 of the vehicle and plug apparatus 12 of energy supply facility 13 are brought into working engagement, high-voltage battery 10 being charged by a current flow from energy supply facility 13.

Internal combustion engine 1 of the plug-in hybrid drive system is connected in known fashion to a fuel tank 14 that has a filling opening for the reception of fuel from filling station 15 into the vehicle.

Internal combustion engine 1 and electric motor 2 are connected to a hybrid drive system control unit 16 and have control applied to them by it. Hybrid drive system control unit 16 has a memory 17 in which one or more operating strategies for applying control to the hybrid drive system are stored. In addition, memory 17 also stores a wide variety of operating parameters of the vehicle which, during operation of the hybrid drive system, are measured by way of sensors (not further depicted) or identified computationally by hybrid drive system control unit 16.

With the aid of the operating parameters that have been determined, and the operating strategy, hybrid drive system control unit 16 of the vehicle establishes an operating point of the hybrid drive system. In addition to the components of the hybrid drive system that are explained in FIG. 1, such as internal combustion engine 1, electric motor 2, transmission 4, and high-voltage battery 10, consideration in terms of the energy balance of the hybrid vehicle is also given to power electronics system 18 that applies control to electric motor 2 and is disposed between electric motor 2 and high-voltage battery 10, and to at least one vehicle electrical system load 19 that is supplied with electricity from high-voltage battery 10 and is connected thereto. Depending on the requirement of the vehicle manufacturer or user, the operating point can be set in energy-optimized or cost-optimized fashion. Variable parameters in this context are, for example, the power output of internal combustion engine 1 and of electric motor 2, and the conversion ratio of transmission 4. If two electric motors 2 are used, the sum of the power outputs furnished by the two electric motors is taken into account. Further parameters then derive from the desired drive torque established by the driver via an accelerator pedal, the vehicle speed, the charge state of high-voltage battery 10, and the power level of the vehicle electrical system load.

To allow energy-optimized driving, i.e., to allow a decision as to how much energy is to be extracted from high-voltage battery 10 and from internal combustion engine 1, the operating strategy thus needs a cost function in which the costs of the energy of high-voltage battery 10, the costs for generating energy with internal combustion engine 1, and the costs for loading energy from external energy supply facility 13, are taken into account. These costs are understood as minimization variables such as CO₂ equivalent, pollutant equivalent, energy equivalent, but also as money for the energy extracted. The recovered energy, i.e., the energy that occurs when electric motor 2 is operated in generator mode and recharges high-voltage battery, is considered to have no cost.

Because the costs for external energy and for fuel are known only to the operators of energy supply facility 13 and of filling station 15, respectively, they must be made known to hybrid drive system control unit 16 so that the latter can take the minimization variables into account when the operating point of the hybrid drive system is calculated by the operating strategy. As is evident from FIG. 2, hybrid drive system control unit 16 is connected for this purpose to a vehicle control unit 20 that has a human-machine interface 21, a Bluetooth interface 22, and a mobile telephone interface 23. In addition, vehicle control unit 20 is connected to a navigation unit 24 that possesses a radio interface 25. In many cases, such interfaces are among the convenience features of a vehicle, and do not need to be additionally retrofitted.

In the simplest case, upon reception of external energy or fuel, the driver manually inputs the minimization variables necessary for calculating the operating point via human-machine interface 21, which is preferably embodied as a keypad.

More convenient, however, is an automatic wireless transfer of the costs, for which purpose the appropriate interface 22, 23, is used depending on the vehicle's distance from energy supply facility 13.

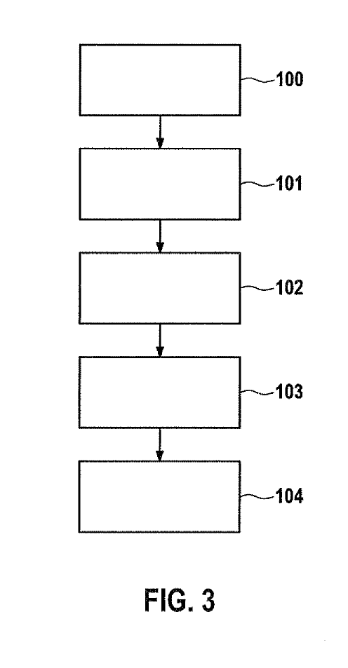

An example of the method according to the present invention will be explained with reference to FIG. 3. In block 100, with the vehicle stationary, high-voltage battery 10 is recharged by delivery of external energy from energy supply facility 13, and the quantity of energy loaded is recorded. Alternatively, however, instead of the quantity of energy loaded, the charge state of high-voltage battery 10 can also be recorded. At the same time, a connection is made via Bluetooth interface 23 of the vehicle to information network 26 of energy supply facility 13, which network possesses an equivalent interface 21′, 22′, 23′, 25′ (FIG. 2); through that connection, the desired minimization variables (costs) are transferred via vehicle control unit 20 to hybrid drive system control unit 16, which stores the minimization variables in memory 17.

In block 101, in the next step of the operating strategy, these costs are additionally taken into account when determining the operating point of the hybrid drive.

In step 102 the vehicle then proceeds to drive, in which context the minimization variables from the varying energy consumption of electric motor 2 and of internal combustion engine 1, and from the energy balance of high-voltage battery 10, are taken into account at predefined intervals when determining the operating point of the hybrid drive system.

In step 103, the minimization variables for the external energy and the fuel are continuously polled from energy supply facilities 13 and filling stations 15, respectively, while the vehicle is being driven; this occurs via mobile telephone interface 23 or radio interface 25. It is thereby possible to determine a priori which filling station 15 or energy supply facility 13 offers the most favorable cost conditions for the energy balance, CO₂ balance, or pollutant balance required by the hybrid drive system.

For the reception of fuel, in step 104 a filling station 15 correspondingly selected in advance is traveled to, and fuel tank 14 is refilled with fuel. During filling, information about the quantity and cost of the fuel being received is transferred to vehicle control unit 20 from an interface 21″, 22″, 23″, 25″ of network 27 of the petroleum supply company, for example from the Internet. via mobile telephone interface 23 of the vehicle. Vehicle control unit 20 transmits this information to hybrid drive system control unit 16, which further processes it.

Because of the great variety of capabilities for polling the minimization variables from energy supply facilities 13 and filling station 15, the method according to the present invention makes possible a flexible and predictive determination of an energy-optimized operating point of the hybrid drive system within an operating strategy.

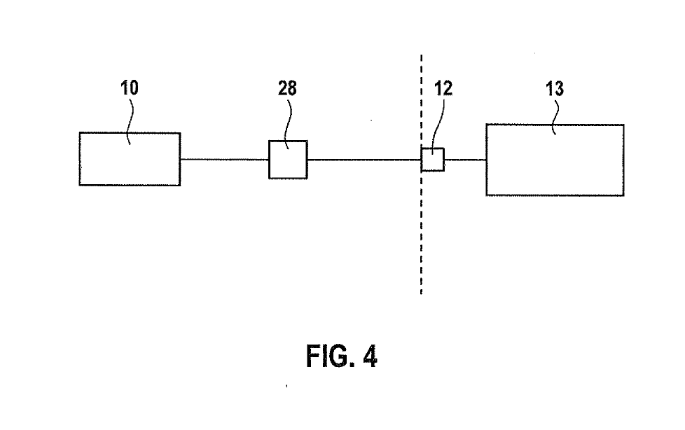

The method according to the present invention functions even if the energy needed for high-voltage battery 10 is extracted from the public electricity network as an external energy source. As depicted in FIG. 4, an onboard charging unit 28 installed in the vehicle is connected to plug device 12 of the external energy source, i.e., the public network. Onboard charging unit 28 leads at the other end to high-voltage battery 10, and transfers energy from public network 13 into high-voltage battery 10.

1-21. (canceled)

22. A method for operating a hybrid drive system of a vehicle in which at least one of an internal combustion engine and at least one electrical machine drive the vehicle, the electrical machine being supplied with energy from an energy reservoir or the electrical machine supplying the energy reservoir with electrical energy, the method comprising:
setting an operating point of the hybrid drive system in a context of a predefined operating strategy which depends on minimization variables that take into account fuel consumption of the internal combustion engine and energy made available by the energy reservoir; and
delivering energy from an external energy source to the energy reservoir, the minimization variables to be taken into account as a result of the delivery of energy from the external energy source into the energy reservoir being evaluated in the operating strategy.

23. The method as recited in claim 22, wherein the minimization variables take into account at least one of an energy equivalent, a CO₂ equivalent, a pollutant equivalent, and a monetary unit.

24. The method as recited in claim 22, wherein the operating point, set via the minimization variables, of the operating strategy of the hybrid drive system is implemented in a cost-function-optimized manner.

25. The method as recited in claim 22, wherein at least one of the minimization variables determined by the delivery of energy from the external energy source to the vehicle, and a quantity of energy loaded, are transmitted to the vehicle from the external energy source.

26. The method as recited in claim 25, wherein transmission from the external energy source to the vehicle of the at least one of the minimization variables determined by the delivery of energy from the external energy source to the vehicle, and the quantity of energy loaded, occurs wirelessly.

27. The method as recited in claim 25, wherein transmission from the external energy source to the motor vehicle of the at least one of the minimization variables determined by the delivery of energy from the external energy source to the vehicle, and the quantity of energy loaded, occurs in contact-based fashion.

28. The method as recited in claim 22, wherein the minimization variables are determined as a function of future values with regard to fuel delivery and energy delivery.

29. The method as recited in claim 22, wherein the minimization variables of fuel and energy are communicated to the vehicle during loading of one of energy or fuel.

30. The method as recited in claim 22, wherein the minimization variables of fuel or energy are transferred to the vehicle while the vehicle is being driven.

31. An apparatus for operating a hybrid drive system of a vehicle in which at least one of an internal combustion engine and at least one electrical machine drive the vehicle, and one of the electrical machine is supplied with energy from an energy reservoir or the electrical machine supplies the energy reservoir with electrical energy, and an operating point of the hybrid drive system is set in the context of a predefined operating strategy which depends on minimization variables that take into account fuel consumption of the internal combustion engine and the energy made available by the energy reservoir, the apparatus comprising:
an arrangement to deliver energy from an external energy source to the energy reservoir, the minimization variables to be taken into account as a result of delivery of energy from the external energy source into the energy reservoir being evaluated in the operating strategy.

32. The apparatus as recited in claim 31, wherein a hybrid drive system control unit determining the operating strategy of the vehicle is connected to the internal combustion engine and to the at least one electrical machine in order to set the operating point, the hybrid drive system control unit leading to a first interface of the vehicle for receiving the minimization variables relevant to the energy that is transferred from the external energy source to the vehicle.

33. The apparatus as recited in claim 32, wherein the first interface is a human-machine interface.

34. The apparatus as recited in claim 32, wherein the first interface is a plug connector for an external communication system.

35. The apparatus as recited in claim 34, wherein information regarding the minimization variables determined by the delivery of energy from the external energy source to the vehicle is modulated onto a charging current that flows from the external energy source to the vehicle upon the transfer of energy.

36. The apparatus as recited in claim 32, wherein the first interface connects the external communication system wirelessly to the vehicle.

37. The apparatus as recited in claim 36, wherein the wireless connection between the external communication system and the vehicle occurs via one of a radio connection, an infrared connection, an inductive connection, or an image recognition device.

38. The apparatus as recited in claim 32, wherein a second interface transfers an information item about the minimization variables of the fuel to be exploited in the internal combustion engine of the vehicle.

39. The apparatus as recited in claim 38, wherein the second interface is a plug contact that is introduced into the fuel delivery device upon reception of fuel, with a result that an electrical signal is conveyed from the fuel delivery device to the vehicle.

40. The apparatus as recited in claim 38, wherein the second interface is one of a radio interface, an infrared interface, an inductive interface, or an image recognition interface.

41. The apparatus as recited in claim 38, wherein at least one of the first interface and the second interface is connected to a vehicle control unit that is connected to the hybrid drive system control unit.

42. The apparatus as recited in claim 31, wherein the external energy source is a public electricity network that is connected via an onboard charging unit to the high-voltage battery.
